(19) United States
(12) Patent Application Publication
(10) Pub. No.: US 2010/0270747 A1
(43) Pub. Date: Oct. 28, 2010

(54) NON-METALLIC BRUSH SEAL

(75) Inventors: Farshad Ghasripoor, Glenville, NY (US); Biao Fang, Clifton Park, NY (US); Eric John Ruggiero, Rensselaer, NY (US); Vasanth Srinivasa Kothnur, Clifton Park, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/429,254

(22) Filed: Apr. 24, 2009

(51) Int. Cl. F16J 15/44; F01D 11/00; F04C 27/00

(52) U.S. Cl. 277/355; 415/230; 415/174.2; 418/104

(57) ABSTRACT

The invention provides, in one aspect, a brush seal comprising brush seal bristles made up of component brush seal filaments. The component brush seal filaments comprise a polyether ketone comprising structural units derived from a diaryl ketone and a diphenolic compound and having a glass transition temperature in excess of 100° C. In a particular embodiment, the component brush seal filaments comprise PEEK. The novel brush seals provided by the present invention present a number of advantages over conventional non-metallic brush seals comprising KEVLAR filaments, such as enhanced friction characteristics and greater stability to fluid lubricants comprising groups reactive with the amide moieties present in aramid filaments such as KEVLAR.

### BACKGROUND

The present invention relates to non-metallic brush seals and their use in various mechanical devices.

### DISCUSSION OF RELATED ART

Brush seals for use in various devices, such as fluid pumps, are known and provide a means of isolating fluids within component parts of rotating machinery such as fluid pumps. Non metallic brush seals comprising aramid filaments (such as filaments made from KEVLAR) offer advantages over conventional metallic brush seals but may suffer hydrolytic and solvolytic instability when used under conditions in which the brush seal is exposed to water or a solvent incorporating hydroxyl or amine groups. Solvolytic attack on the amide moieties of the polyamide which constitutes the brush seal filaments can result in performance losses and ultimate failure of the brush seal.

The present invention addresses weaknesses of conventional non-metallic brush seals by providing brush seals comprising brush filaments comprising organic materials which are less susceptible to hydrolytic and solvolytic attack but which possess the requisite mechanical properties to be fashioned into and used as filaments in a brush seal device.

### BRIEF DESCRIPTION

In one embodiment, the present invention provides novel brush seals comprising brush seal bristles comprising filaments comprising a polyether ketone comprising structural units derived from a diaryl ketone and a diphenolic compound and having a glass transition temperature in excess of 100° C.

In an alternate embodiment, the present invention provides a turbomachine comprising a novel brush seal comprising brush seal bristles comprising filaments comprising a polyether ketone comprising structural units derived from a diaryl ketone and a diphenolic compound and having a glass transition temperature in excess of 100° C.

In yet another embodiment, the present invention provides a fluid pump comprising a screw rotor and at least one novel brush seal comprising brush seal bristles comprising filaments comprising a polyether ketone comprising structural units derived from a diaryl ketone and a diphenolic compound and having a glass transition temperature in excess of 100° C.

In yet another embodiment, the present invention provides a fluid pump comprising a screw rotor and at least one brush seal comprising brush seal bristles comprising filaments comprising PEEK.

### BRIEF DESCRIPTION OF THE DRAWING

These and other features, aspects, and advantages of the present invention will become better understood when the following detailed description is read with reference to the accompanying drawing in which like characters represent like parts throughout the drawing, wherein:

FIG. 1 is an embodiment of the invention which is a brush seal comprising brush seal bristles comprising PEEK filaments.

### DETAILED DESCRIPTION

As discussed in detail below, embodiments of the present invention include novel brush seals comprising brush seal bristles comprising filaments comprising a polyether ketone comprising structural units derived from a diaryl ketone and a diphenolic compound and having a glass transition temperature in excess of 100° C. The novel brush seals of the present invention are superior to known non-metallic brush seals comprising brush seal bristles comprising aramid filaments due to the greater hydrolytic and solvolytic stability of polyether ketone relative to the polyamide comprising the aramid filaments, and the fact that acceptable brush seal bristles can be produced from polyether ketone filaments. Aramid filaments are exemplified by the commercial aramid filaments NOMEX and KEVLAR developed by Dupont. The novel brush seals provided by the present invention are useful in turbomachines such as fluid pumps. For the purposes of this disclosure, a turbomachine is a machine comprising at least one rotor.

Polyether ketones are well known engineering thermoplastics which are characterized by excellent chemical resistance and mechanical properties. A variety of polyether ketones are available commercially. Polyether ketones are in many cases characterized by a high (greater than 200° C.) melting point and a glass transition temperature in excess of 100° C. The partially crystalline nature of polyether ketones enables these materials to resist swelling and/or dissolution by organic solvents such as alcohols, and the high glass transition temperature of these materials allows articles formed from these materials to be used at elevated temperatures without loss of dimensional integrity of the article.

The polyether ketone, PEEK, is semicrystalline (i.e., partially crystalline) and comprises structural units derived from 4,4′-difluorodiphenyl ketone and hydroquinone. PEEK is an engineering thermoplastic which is said to be “semicrystalline” because it typically comprises both crystalline and amorphous domains. PEEK exhibits a melting point at about 340° C. and has a glass transition temperature (Tg) of about 140° C. PEEK exhibits excellent mechanical properties and chemical resistance relative to aramids such as KEVLAR.

It has been found that polyether ketones such as PEEK can be formed into filaments suitable for use in brush seal bristles, and non-metallic brush seals can be prepared from such bristles. The present invention provides an alternative to polyamide-based non-metallic brush seals, which because they contain amide linkages along the backbone of the polymer constituting them, are prone to solvolytic and hydrolytic instability. The novel non-metallic brush seals provided by the present invention combine the excellent chemical and mechanical properties of polyether ketones, generally, with an ease of manufacture at least equivalent to the ease of manufacture of non-metallic brush seals comprising polyamide filaments.

In one embodiment, the novel brush seal provided by the present invention comprises bristles made up of filaments comprising a polyether ketone comprising structural units derived from a diaryl ketone and a diphenolic compound and having a glass transition temperature in excess of 100° C. Thus the filaments serve as components or subunits of the brush seal bristles. The brush seal is said to comprise brush seal bristles, and the brush seal bristles are said to comprise the filaments, and the filaments are said to comprise the polyether ketone. In one embodiment, the filaments making up the brush seal bristles comprise a polyether ketone selected from the group consisting of PEK, PEKK, and PEEK. In an alternate embodiment, the filaments making up the brush seal bristles comprise a polyether ketone which is PEEK. In one embodiment, the filaments making up the brush seal bristles consist essentially of the polyether ketone PEEK.

In one embodiment, the present invention provides a multi-phase twin screw pump comprising a non-metallic brush seal of the invention and a pump bearing lubricated by mixture of water and ethylene glycol. In one embodiment, the multi-phase twin screw pump is configured such that during operation, a specified portion of the lubricant mixture is allowed to flow into and mix with the pump process fluid (the fluid being acted upon by the pump), the non-metallic brush seal of the invention providing a means of limiting the amount of lubricant mixture which enters and mixes with the pump process fluid. Such a configuration provides a number of advantages, among them that a simple brush seal may be used instead of a more complex face seal, for example, but requires that sufficient additional lubricant mixture be added to compensate for that which traverses the brush seal mixes with the pump process fluid and is transferred out of the pump with the process fluid. Thus, it is necessary that the rate at which the lubricant mixture traverses the brush seal be controllable in order to calculate the amount of make-up lubricant mixture needed, and to limit the amount of the lubricant mixture expended while providing for adequate lubrication to components such as pump bearings, while preventing the flow of pump process fluid across the brush seal in the opposite direction. While a variety of brush seals can be used to achieve these purposes, the non-metallic brush seals of the present invention are believed to be especially advantageous when the lubricant mixture comprises water or a solvent comprising one or more hydroxyl groups, such as ethylene glycol. Non-metallic brush seals comprising polyamide bristles are expected to undergo performance degradation as amide moieties along the polyamide chain are attacked and cleaved either by solvolysis or hydrolysis. Non-metallic brush seals comprising polyether ketone bristles are expected to be far more resistant to solvolysis and hydrolysis, since unlike polyamides, polyether ketones generally do not contain amide moieties or other hydrolytically or solvolytically reactive groups. The polyether ketones “PEK”, “PEKK”, and “PEEK” are representative of especially suitable polyether ketones having superior hydrolytic and solvolytic stability relative to polyamides. Polyether ketones are, in addition, more chemically resistant to hydrochloric acid and hydrogen sulfide.

Current state of the art non-metallic brush seal bristles are made of KEVLAR filaments, also referred to as KEVLAR fibers. KEVLAR is a referred to as “para-aramid” and comprises structural units derived from para-phenylene diamine, and structural units derived from terephthalic acid or a derivative of terephthalic acid, for example diphenyl terephthalate. However, polyamide filaments such as KEVLAR filaments are generally less stable chemically when exposed to water-ethylene glycol mixtures than are polyether ketone filaments. Prolonged exposure of KEVLAR filaments to lubricant mixtures comprising water and ethylene glycol can lead to loss of filament stiffness and eventually filament degradation. Loss of filament stiffness and or filament degradation will reduce sealing capability of the brush seal over time. The novel brush seals provided by the present invention provide for greater chemical resistance to a variety of lubricant mixtures comprising components which attack amide linkages; for example water, alcohols, and amines. Greater chemical stability of the component polymer helps to retain performance characteristics of articles comprising the polymer, such as the stiffness of a filament comprising the polymer. It is believed that enhanced polyether ketone filament stiffness will contribute positively to the useful service life of a non-metallic brush seal comprising such polyether ketone filaments.

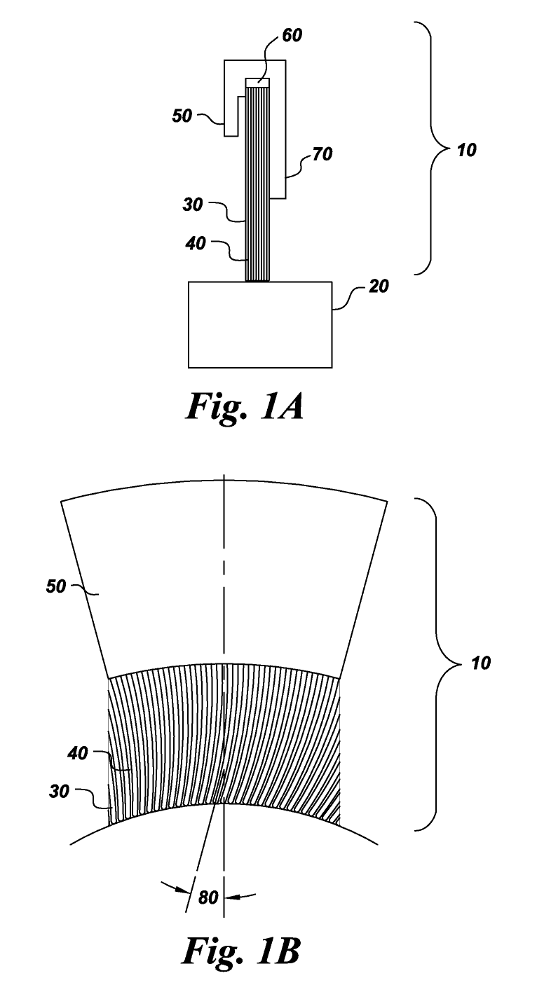

The novel non-metallic brush seals of the present invention may be prepared using methods analogous to those used to prepare conventional non-metallic brush seals. Polyether ketone filaments may be packed in rows to form bristle packs which constitute the main sealing element of the brush seal. The bristles are fixed at one end in a support ring with the free end directed toward the ring center and extending beyond the inside edge of the ring (See FIG. 1). Bristles are angled or “canted” to 15-45 degrees in the direction of rotation a rotor in contact with the bristles (See FIG. 1). The free height of the bristles extending beyond the inner diameter of the ring support is one of the factors which determines the sealing and pressure capability of the brush seal. Brush seal bristles in contact with the rotor surface provide the seal. Another design factor is the diameter of the filaments. In the case of a liquid brush seal, filaments are preferred to be in a range from about 10 to about 30 micrometers in diameter. The number of rows of bristles, also referred to herein as the “bristle pack density”, may also be used to control brush seal performance.

Another factor which may affect non-metallic brush seal performance is the friction behavior between brush seal bristle filaments and the rotor, and this can be a critical design parameter in certain applications. KEVLAR is well known as a high friction material often used in high friction environments such as automotive clutches and brakes. The coefficient of friction in a typical KEVLAR-stainless steel combination is typically in a range from about 0.40 to about 0.50 under “dry” conditions. Significantly, the corresponding coefficient of friction in the corresponding PEEK-stainless steel combination is in a range from about 0.25 to about 0.30. KEVLAR is particularly noted for its high coefficient of friction under “wet” conditions such as those used in brush seal applications wherein the brush seal bristles are in contact with a moving rotor. Under such circumstances, a higher coefficient of friction may lead to greater wear of the bristles at the rotor contact points, and bristles having a lower coefficient of friction would be highly desirable. In addition, a higher level of friction between the brush seal bristles and the rotor may result in unwanted heating of the rotor and brush seal resulting in unforeseen changes in brush seal permeability to fluids in contact with the brush seal.

An additional advantage of the brush seals provided by the present invention is that the use of polyether ketone bristle filaments permits “dry running” of the bristles against the rotor, an important advantage in instances in which the flow of fluid lubricant to the brush seal is restricted during operation of a device comprising the brush seal in contact with a rotor, for example a fluid pump. This is an important advantage over mechanical shaft seals that are commonly used in fluid pumps wherein restriction or loss of fluid lubricant can lead to irreparable damage to the shaft seal and ultimately to the pump itself.

In one embodiment, the present invention provides a brush seal for use in a multi-phase pump. Conventional multi-phase pumps use complex mechanical shaft seals to prevent process fluids from contacting the pump bearings. Such shaft seals comprise at least two sealing elements, one rotating element (flexible element) and one stationary element (rigid element) that are separated by a clean fluid film. The fluid film thickness is a function of hydraulic pressure balance between the sealing elements. The sealing elements require a fluid lubricant to maintain the film during operation. Loss of the fluid lubricant can lead to severe friction between the sealing elements, wear and failure. In addition, contamination of the seal elements by the process fluid may also lead to shaft seal damage and failure.

As noted, in one embodiment, the present invention provides a turbomachine comprising at least one brush seal comprising brush seal bristles, said bristles comprising filaments comprising a polyether ketone comprising structural units derived from a diaryl ketone and a diphenolic compound and having a glass transition temperature in excess of 100° C.

In one embodiment, the turbomachine provided by the present invention comprises bearings in contact with a fluid lubricant which is also in contact with the novel brush seal provided by the invention. In one embodiment, the fluid lubricant comprises water. In an alternate embodiment, the fluid lubricant comprises ethylene glycol. In yet another embodiment, the fluid lubricant is comprises ethylene glycol and water.

Turning now to the FIGURE, FIG. 1 illustrates a brush seal 10 of the invention in contact with rotor 20 shown as a cross section 1a and an axial view 1b. The brush seal comprises bristles 30 comprising PEEK filaments 40. The brush seal further comprises a front plate 50, a bristle holder 60 and a back plate 70. In view 1b, bristles 30 and component PEEK filaments 40 are shown in contact with rotor 20. It should be noted that the brush seal bristles are in contact with the rotor at a cant angle 80.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A brush seal comprising brush seal bristles, said bristles comprising filaments comprising a polyether ketone comprising structural units derived from a diaryl ketone and a diphenolic compound and having a glass transition temperature in excess of 100° C.

2. A turbomachine comprising the brush seal of claim 1.

3. A turbomachine according to claim 2 comprising bearings in contact with a fluid lubricant comprising water, said fluid lubricant also being in contact with the brush seal.

4. A turbomachine according to claim 2 comprising pump bearings in contact with a fluid lubricant comprising ethylene glycol, said fluid lubricant also being in contact with the brush seal.

5. A turbomachine according to claim 2 comprising pump bearings in contact with a fluid lubricant comprising ethylene glycol and water, said fluid lubricant also being in contact with the brush seal.

6. The brush seal according to claim 1, wherein said polyether ketone comprises structural units derived from 4,4′-difluorodiphenyl ketone.

7. The brush seal according to claim 1, wherein said polyether ketone comprises structural units derived from hydroquinone.

8. The brush seal according to claim 1, wherein said polyether ketone is selected from the group consisting of PEK, PEKK, and PEEK.

9. The brush seal according to claim 1, wherein said polyether ketone is PEEK

10. A brush seal comprising filaments consisting essentially of PEEK polyether ketone.

11. A fluid pump comprising a screw rotor and at least one brush seal comprising brush seal bristles comprising filaments comprising a polyether ketone comprising structural units derived from a diaryl ketone and a diphenolic compound and having a glass transition temperature in excess of 100° C.

12. The pump according to claim 11 which is a twin screw pump.

13. The pump according to claim 12, wherein the polyether ketone is selected from the group consisting of consisting of PEK, PEKK, and PEEK.

14. The pump according to claim 11, wherein the polyether ketone is PEEK.

15. The pump according to claim 11, wherein the brush seal is in contact with a fluid lubricant comprising water.

16. The pump according to claim 11, wherein the brush seal is in contact with a fluid lubricant comprising ethylene glycol.

17. The pump according to claim 11, wherein the brush seal is in contact with a fluid lubricant comprising water and ethylene glycol.

18. The pump according to claim 11 which is a multi-phase pump.

19. A fluid pump comprising a screw rotor and at least one brush seal comprising brush seal bristles comprising filaments comprising PEEK.

20. The fluid pump according to claim 19 which is a twin screw pump.
